(19) United States
(12) Patent Application Publication
(10) Pub. No.: US 2006/0099315 A1
(43) Pub. Date: May 11, 2006

(54) Method for making a cake or culinary preparation that can be preserved for a long time at room temperature and is ready to eat

(76) Inventor: Rene Le Flecher, Versailles (FR)

Correspondence Address: Lumen Intellectual Property Services, 2345 Yale Street, 2nd Floor, Palo Alto, CA, 94306, US

(21) Appl. No.: 10/522,867

(22) PCT Filed: Jul. 31, 2003
(86) PCT No.: PCT/FR03/02436

§ 371 Date: Aug. 29, 2005

(30) Foreign Application Priority Data
Jul. 31, 2002 (FR) 0209761

(51) Int. Cl. A23L 1/00

(52) U.S. Cl. 426/564

(57) ABSTRACT

A method of manufacturing a ready-to-eat cake or culinary preparation with a long, extended shelf life at ambient temperature, in which the basic mixture is prepared with selected ingredients having a low water content and foamed under inert gas pressure prior to being packaged in a container. After packaging and before the container is closed, a vacuum is applied. The base can be deaerated prior to foaming, subjected to a microbe-destroying stabilisation treatment, and/or subjected to a pasteurisation treatment. The low water content of the ingredients resulting in a base water activity value of between approximately 0.70 and 0.92, preferably between 0.85 and 0.90.

### FIELD OF THE INVENTION

The present invention generally relates to ready-to-eat food preparation and packaging. More particularly, it relates to a method of manufacturing a ready-to-eat cake or culinary preparation with extended, long shelf life at room temperature.

### DESCRIPTION OF THE RELATED ART

The conventional way of manufacturing a cake of the sponge type, the best known of which being the “pound cake”, starts with a base, which is prepared by mixing intimately the four main ingredients, namely eggs, flour, butter and sugar, to obtain a homogeneous mixture. Savoury cakes contain barely any of the last ingredient, which is replaced in part by salt and often by evaporated or powdered milk.

Because the base has a very considerable influence on the shape and texture of the cake, an additive, or more precisely, a mixture of additives is virtually always added, in the form of a raising agent. The composition of the raising agent may be adapted as a function of the proportions of the main ingredients, the relevant conditions, and the method of baking in the oven. On contact with the water supplied by the eggs, the raising agent breaks down to produce carbon dioxide.

In certain cakes, live yeast may be added, with the same main objective of including carbon dioxide in the mixture by fermentation.

Separating the eggs and stiffly beating the egg whites, which are then incorporated into the mixture, also makes it possible to include gas. In this case, the gas is air.

Whether the gas dissolved in the mixture is carbon dioxide or air, the effect is the same: exposed to the heat in the oven, it expands and increases the volume of the cake, the shape of which is set by baking.

To vary the presentation and to extend the range of shelf life for cakes of this type, the main ingredients may be replaced entirely or in part. For example, the flour, which participates in forming the structure, may be replaced by another binder such as starch; the sugar, which above all provides the cake with flavour, may be replaced by honey or other sweeteners; and the butter may be replaced by various fatty substances. In contrast, replacing the eggs with other proteins is more difficult because, although some proteins foam correctly, they have only in part the capacity to produce thermo-irreversible gels.

Another way of extending the range of shelf life is to modify consistency and/or flavour by adding various fillings before baking, such as glac\acute{e} fruits in an English-style fruit cake or olives in a savoury cake to be eaten as an aperitif. After baking, the cakes which are then used as a base may be decorated or topped to vary the flavour or presentation.

Still with the same objective and acting principally on the flavour of the cake, it is also possible to incorporate flavourings. These flavourings may have various origins and take various forms: powdered, such as cinnamon, liquid, such as essential citrus fruit oils, alcoholic extract of vanilla, commercial alcohols or liqueurs such as rum, branded liqueurs, etc.

Once the ingredients, additives and flavourings have been mixed together, the mixture obtained may be deposited on a baking tray, but most often it is poured into a cake mould and put in the oven at a temperature and for a period of time, both of which depend on the size and shape of the mould. Other baking methods may be used, in particular, frying in the case of clafoutis, although they are less common.

At the beginning of oven baking, the water, which starts to vaporise, the air included in the mixture and the carbon dioxide originating from the reaction of the raising agent or the fermentation of the yeast expand, increasing the internal pressure as the surface of the mixture is not very porous. Since the mixture is held at the sides by the walls of the mould, the pressure is only able to work upwards, where the external pressure is weaker. Even if some of the gases escape, the remaining fraction is sufficient to increase the volume of the mixture, which is still fluid at the beginning of baking. As the temperature increases, the mixture hardens and the starch from the gelatinised flour and the proteins originating substantially from the eggs coagulate to fix the shape of the cake, the density of which varies from 0.400 to 0.700 kg per dm³, approximately.

Baking is accompanied by dehydration, which increases as the temperature rises inside the cake but is greater at the surface, since the temperature rises more there. This allows the formation of a beautifully golden coloured crust which is characteristic of an oven-baked cake.

Developments in flavour accompany developments in texture and colour. They are essentially due to the production of aromatic compounds resulting from sugar caramelisation reactions and, in particular, Maillard reactions between the sugars and the proteins. The Maillard reactions are promoted by the temperature increase and dehydration.

The first industrial companies to produce and sell packaged cakes manufactured them in much the same way as the housewife or pastry cook. They noticed that it was sufficient to extend the life of the cake by either reducing the amount of water added to the mixture at the start or by increasing the amount of water evaporated.

In effect, dehydration allows, depending on how advanced it is, to retard or prevent the growth of the microbes which can only multiply if they find sufficient water available in the cake. Depending on the composition of the product, more or less water is available. For example, it is strongly bound to the sugar and still more so to the salt but less so to the flour, such that there can only be a direct relationship between water content and water activity for a specific product whose formulation is fixed. Thus, to estimate the possibility of microbial growth, scientists prefer, instead of measuring water content, to measure its availability, which is known as water activity (Aw), calculated, on a scale which goes from 0 for a totally dry product to 1 for pure water, by means of special apparatus available in many laboratories.

However, depending on whether bacteria, yeast or moulds are involved, there has to be more or less water activity to allow metabolism, growth and multiplication of the microbes and, for certain of them, the production of toxins.

In principle, depending on the bacterial strains, growth is possible between 1.00 and 0.78 approximately, with two significant intermediate values: 0.90, being the value beneath which heat-resistant bacteria cannot develop, and 0.84, being the value at which Staphylococcus aureus, which may produce toxins at the lowest water activity value (0.86), can no longer develop.

Yeasts and moulds may develop at lower water activity values, depending again on type, and theoretically certain strains of mould may develop down to a water activity of 0.60.

However, factors other than water activity may retard or inhibit the possibilities of microbial growth, such as quality and “cleanness” of the raw materials, nutritive composition of the medium, pH value, oxygen content, presence or absence of inhibitors such as potassium sorbate, etc.

The influence of all these factors has been studied and applied in accordance with hurdle technology, which makes it possible to control microbial proliferation in products with an intermediate moisture level, i.e., products having a water activity of between 0.70 and 0.90, although these values vary slightly depending on the particular specialist.

After baking the cake, the water content of the mixture, which, prior to being put in the oven, was greater than 25% with a water activity greater than 0.90, drops to around 20% with an activity of around 0.80. However, this value is not sufficiently low for it to be possible to keep the cake for several months because on contact with air the cake may rapidly be re-contaminated prior to packaging, even if contaminants and/or contaminating microbes had been killed during baking. To guarantee good keeping quality, industrial companies increase dehydration to further lower the water activity to between 0.70 and 0.75, adjusting oven time and temperature accordingly, hence ensuring stability under correct storage conditions such as those applied industrially, even if recontamination does occur.

The cake exhibiting the desired water activity is then packaged in packaging which has as far as possible to prevent dehydration occurring during storage and to protect it against external contamination. This is how, among other things, pound cakes and madeleines are stored under ambient conditions for several months.

A low water content does have consequences for the organoleptic qualities of the cake, which may appear dry and lack moistness. This impression of dryness may be increased if the cake is kept for some time due to the crumb becoming stale, a situation that is promoted and accelerated by a low moisture content. One of the means of overcoming the loss of moistness is to raise the fat and sugar contents, which has the disadvantage of increasing the cost and calorific value of the cake. This method is used, of course, for the manufacture of some small dry biscuits, but consumers who care about their figure/weight tend to reject food products or items that are high in calories.

Under certain conditions, it is possible to keep a cake with a higher water activity level. However, in these cases, it is necessary to use preservatives to improve stability, which may also put off the consumer, or to package the cake in a very protective packaging, into which it is possible to inject certain inert gases or to deposit an oxygen absorber which may appear suspect to the consumer and may increase the cost of manufacture.

Continuing dehydration to improve stability may result in an increase in the production of aromatic compounds, which is desirable in certain cakes. On the other hand, these compounds, which are often very highly coloured, may also have an unfavourable action in certain types of cake with a traditionally light-coloured crumb, such as sponge fingers or cakes containing fruit-based fillings, the colour of which darkens the higher the temperature and the longer the period of exposure to heat.

Furthermore, oven baking, even under temperature control, may degrade the most highly heat-sensitive flavourings and cause evaporation of the most volatile thereof.

Oven baking certainly has many advantages. However, certain types of cake could suffer under even moderate heat treatment. Moreover, the relatively low moisture level, which his needed to obtain a water activity value allowing good microbiological stability, could cause certain deterioration of organoleptic qualities during the keeping period.

Industrial companies have thus noted that the traditional method, even with improvement, of manufacturing cakes that can be kept for several months applies only to certain types of cake, such as madeleines or fruit cakes, savoury cakes containing olives from the fresh food department.

To eliminate these limiting factors as much as possible, several proposals have been made.

EP 0 868 850 proposes to manufacture a ready-to-use, environmentally stable cake mix. The cake mix has to be oven-baked in the traditional manner by the user, who is supposed to consume the cake quickly thereafter.

A similar approach is proposed in WO 00/72687, which relates to a brownie mix packaged directly in the baking mould.

WO 95/09543 describes a recipe for a cake, using a traditional manufacturing method. The recipe contains around 30% of various fruits and is very pleasant to consume. However, given the quantity of water supplied by the fruit, shelf-life is limited at ambient temperature.

EP 1 023 839 proposes to manufacture, in a traditional manner, a savoury cake with a salt content of up to 2%, which is restrictive in terms of flavour, manufacture suffering from the same limitations.

These two products may be sold with a short optimum use-by date, which may be extended by keeping the products in chilled conditions.

EP 0 930 014 proposes a method for manufacturing mixtures for various cakes. The method involves air-based foaming. The fat content in the form of oil is added in a second stage, which makes it possible to reduce the quantity required. Depending on the type of mixture, it is possible to reduce or eliminate the use of emulsifier or raising agent. The oven baking method is traditional.

EP 1 106 069 proposes a similar two-stage foaming method. The first stage consists of preparing a base comprising egg white and proteins of various origins which are highly foamed to obtain a very low density. A second, unfoamed base containing the other ingredients of the recipe is then added to the first, highly foamed base to obtain, after mixing, a mixture having an intermediate density which, after baking in the oven, is between 0.200 and 0.350 kg per dm³.

According to the method described in EP 0 406 213, it is possible to produce cakes with a shelf life of several months. The method consists in packing a mixture of classic composition in a glass container closed either by a removable lid or by a fixed lid fitted with a valve. The two systems allow the gases produced during oven-baking to be evacuated. On cooling, the pressure reduction brought about by condensation of the water vapour contained in the headspace between the product and the lid sticks the latter against the rim of the container or, with the other system, the valve closes. However, control of the internal pressure reduction is delicate, even if ways of setting the correct value have since been proposed. If the pressure reduction is too slight, the lid is stuck down insufficiently tight and there is a risk that air will get in. On the other hand, if the pressure reduction is too great, it is difficult to take off the lid to open the container. It also seems that heat treatment can only take place in an oven in a glass or ceramic container that can withstand temperatures of 150° C. to 200° C. for several tens of minutes.

### BRIEF SUMMARY OF THE INVENTION

An object of the present invention is to eliminate certain limiting factors listed above and to provide a method of manufacturing cakes or cake-related preparations with a long, extended shelf life at ambient/room temperature.

The present invention relates to a method of the type defined above, characterised in that
the base is prepared with ingredients having a low water content,
before packaging, the base is foamed under inert gas pressure, and
after packaging, but before the container is closed, a vacuum is applied.

Due to the expansion under inert gas pressure, on the one hand, and the application of a vacuum, on the other hand, the mixture increases in volume and the air in the head space in the container is evacuated, which reduces the amount of oxygen in the container and, consequently, increases the stability of the product and thus its shelf-life.

Advantageously, the mixture is prepared with ingredients having a water content resulting in a mixture water activity value of between 0.80 and 0.92, preferably between 0.85 and 0.90.

Also advantageously, after packaging, the mixture may be subjected to a microbe-destroying stabilisation treatment, for example, pasteurisation.

The invention will be better understood by one skilled in the art with the aid of the following description of certain embodiments.

### DETAILED DESCRIPTION OF THE PREFERRED EMBODIMENT(S)

The invention provides the following five types of cake or cake-related preparations.
1. Sweet cakes similar in terms of flavour and presentation to pound cakes, sponge cakes or English-style fruit cakes.
2. More or less aerated savoury cakes, the flavouring of which is substantially provided by the fat content used (e.g., olive oil, smoked pork lard, etc.) and which may contain fillings of vegetables, meat, and even certain more or less dehydrated fruits.
3. Original design cakes in which the proportion of fruit in the form of concentrated juice or puree and more or less dehydrated pieces is considerable (10 to 30%), which reduces the pH thereof to around 6.5.
4. Savoury or sweet cake-related preparations such as full breakfasts, fillings, products resembling traditional mousses or soufflés, more or less foamed toppings, which may be included in the same container as the cake or packaged separately.
5. Egg-free sweet or savoury or sugar- and salt-free products meeting the special requirements associated with allergy or health problems or meeting the demand for greater well-being.

It should be noted that, although baking takes place at a moderate temperature, it is nonetheless necessary for the method disclosed herein to allow the achievement of a cake or cake-related preparation having the characteristic flavour, appropriate volume of similar commercial products and equivalent or better stability at ambient temperatures. For those products with no traditional equivalent, the parameters selected are those that allow the achievement of a better texture and better keeping quality.

Achieving the Characteristic Flavour

Baking, according to the proposed method, takes place at moderate temperature in a packaging sealed by the application of a lid or protective cover, which does not allow the production of aromatic compounds like in an oven-baked cake, since dehydration is impossible. It is thus necessary for the raw materials used in manufacture of the mixture to contain them already, only those being used which have undergone sufficient heat treatment together with evaporation consistent with causing therein Maillard reactions or the onset of caramelisation. It is possible, however, to pass the container under an infrared strip prior to closure, which has the advantage of giving a golden appearance on opening.

Sometimes it is desirable to use ingredients containing only small amounts of colouring compounds such as those that have to be used in the manufacture of a fruit cake. In this case, it is necessary to preserve as much as possible the colour of the fruit, or in the manufacture of a cake flavoured with a subtle aroma, so as not to mask the flavour and the colour.

The invention is based on mixtures prepared with ingredients having a low water content.

The ingredients used are other anhydrous or have a lower water content than similar untreated ingredients. This simplifies the obtainment of the desired water activity and does not require the use of moistening agents in most cases or the addition of large amounts of sugar or salt. In effect, to lower the water activity of the product, it is necessary to reduce the quantity of water or to increase that of the ingredients which reduce the availability of the water.

In some embodiments, the main ingredients are whole concentrated eggs, from which 50% of the water has been removed by ultrafiltration. In some embodiments, the main ingredients are egg whites, from which the amount of water removed may reach 80%. In yet some embodiments, the main ingredients are egg yolks, which naturally have a relatively low water content, even if these egg products undergo pasteurising heat treatment to kill the dangerous microbes such as salmonella. It is preferable to use concentrated eggs rather than spray-dried eggs, i.e., drier eggs, since the functional qualities are better preserved. It is also possible to use proteins of animal or vegetable origin instead of eggs.

The flour used is cleaner at the start than traditional flour. According to the invention, the flour is additionally subjected to a complementary heat treatment to destroy as many microbes as possible and to deactivate the enzymes present (essentially amylases). The water content falls from 12 to 6% after this treatment. The oil and white or brown sugar naturally have an elevated dry content. The butter contains around 15% water. Alternatively, anhydrous butter may readily be utilized.

It is possible to use other raw materials for the manufacture of cake-based preparations, such as various starches, sugars, proteins, fruits or vegetables etc., on the condition that the organoleptic qualities of the ingredients selected make it possible to manufacture products with a good flavour and a good texture, that the moisture content of the mixture after mixing makes it possible to obtain good water activity, and that the standards of microbiological and enzymatic cleanliness applied ensure a good keeping quality after heat treatment at moderate temperature.

The ability to dehydrate and concentrate the aforementioned raw materials at low or elevated temperature to limit, when necessary, the production of aromatic compounds is known in the art and thus not further described herein.

A great advantage of the invention is the ability to achieve, among others, such varied colours and flavours in cakes and cake-based preparations.

Achieving Volume

The method of the present invention comprises a step of baking the cake in closed packaging, making it impossible for the mixture to expand. It is thus necessary for the mixture, at the moment when it is packaged in the container serving as a baking mould, already to exhibit the density of an oven-baked culinary preparation or cake.

To accomplish this, the method comprises a step of subjecting the mixture to an expansion operation, which consists of incorporating a gas to increase the volume thereof, thereby diminishing the density. Note that the term used hereinafter for “density” will be “densite”, which has come into general usage among French engineers, rather than the correct term “masse volumique”.

The advantage of this expansion operation is that it is no longer necessary to add a raising agent or even in most cases emulsifiers; despite their use being generally accepted by consumers, those who are most concerned about the presence of additives in food products may respond favourably to the absence thereof.

Two types of apparatus are used for expansion: pressurised mixer foamers and continuous foamers. Depending on the composition of the mixture, i.e., its greater or lesser viscosity and the presence or absence of filling, one or the other is preferably used.

For thick mixtures containing a filling, it is preferable to use a mixer foamer comprising a vat in which different foaming or mixing accessories, to which a planetary movement is imparted, may be adapted to the product to be foamed at variable speeds. In this apparatus, it is possible to apply a vacuum for deaeration purposes or to inject various gases under pressures of up to 2 to 3 bar.

The mixture preparation cycle begins with the formation of an emulsion by gradually pouring a liquid or liquefied fatty substance onto concentrated eggs and/or the proteins, the other liquids and other ingredients then being added.

Depending on the composition of the mixture, it is sometimes necessary to add an emulsifier, with the objective of increasing the stability and speed of formation of the emulsion, although that is not necessary in most cases.

Then, with stirring and pressure, an inert gas is dissolved in the mixture for a period of time. The length of the time depends on the type of mixture and the temperature thereof, and the solubility of the gas and the density sought. A food-grade inert gas (N₂, N₂O, CO₂) is preferable to prevent oxidation of the fat content during storage.

The filling, especially if it is fragile, is added at the end of the cycle and mixed at slow speed.

At the output of the mixer, the gas compressed in the mixture is expanded and the density is lowered.

The continuous foamer is more suitable when the mixture is quite liquid and thus readily pumpable, and the great advantage of this apparatus is that adjustment of the density is more precise than with a static mixer foamer.

To prepare the mixture, it is necessary to first mix the ingredients in a mixer beater under inert gas, then to pump the mixture continuously as far as the foaming head, where the gas is injected with intense stirring at a greater or lesser pressure. The amount of gas injected makes it possible to predict the final density quite precisely.

In theory, it is possible to effect foaming without the filling and then add it afterwards. However, it is difficult to fix on a continuous basis a constant ratio between the amount of mixture and the amount of filling, especially under inert gas.

Therefore, it is preferable to have two systems for optimising foaming in qualitative and also economic terms. The continuous foamer is cheaper and often exhibits better productivity, while the static mixer foamer may foam more products which are often more difficult to prepare.

Packaging

All the materials commonly used to manufacture containers and other packaging may be suitable, though it should be noted that plastics are particularly suitable, as the heat treatment is performed at a temperature which tends more towards the low side. Glass and plastics have the advantage of allowing reheating in a microwave oven if desired.

It is necessary to perform packaging under inert gas, which numerous packaging machines are able to do, to ensure thoroughly anaerobic conditions.

The base is foamed before packaging and, if the density obtained is not low enough, it is possible to lower it by placing the container filled to the desired weight with mixture in a chamber in which a vacuum may be created. Most modern crimping, closing and heat-sealing machines are capable of applying a vacuum before closing the container.

Since the base has been foamed under pressure and the dissolved gas is thus present in a large quantity, application of a partial vacuum causes the mixture to rise to the selected level in the container, which is closed immediately.

Stabilisation and Baking

Commercial stability of sterilised preserved foods is obtained by applying sufficient heat treatment to a product packaged in a sealed packaging as described above.

This heat treatment is variable: if the water activity of the product is high, the temperature inside the container is held for several minutes well above 100° C. to achieve maximum microbe destruction, similar to the sterilisation treatment applied to canned peas.

This treatment, which is sufficient to ensure stability, is also sufficient to cook the peas, but in certain cases it may be insufficient when certain qualities/quantities of bean have to be cooked. It may also be too intensive when it is a question of preserving cakes having a water activity of around 0.95. The sterilised cakes which may be found in shops are generally darker than is desirable, in particular in the case of rice cakes, the colour of which would be expected to tend more towards white and the rice texture which would be expected still to be slightly firm.

The term sterilisation is used when a long, high temperature treatment is applied, although it is not possible to achieve complete sterility, since microbiological decay is logarithmic; however, the chances of finding a single microbe in a container are less, the higher the sterilising value (combination of temperature and duration) and the lower the microbiological burden in the product to be sterilised at the outset.

The term pasteurisation is used when the heat treatment is moderate and it is this process which is applied when it is wished to keep milk under refrigeration for longer without degrading the nutritive components, such as certain vitamins, or it is wished to stop fermentation in beer by killing the yeasts which exhibit very poor resistance to heat, such as moulds or certain vegetative microbes, the others not being able to develop because of the presence of alcohol.

There are only two conditions under which sterilisation treatment is not applied to preserved foods and which pasteurisation treatment is sufficient to ensure stability at ambient temperature for several months: when the pH is lower than 4.5 or when the water activity is lower than 0.90 and hurdle technology is applied. Under these conditions, heat-resistant or spore-forming microbes cannot develop. According to the invention, the second conditions is preferably applied to products needing pasteurisation treatment. However, whichever method is selected, the aim is to guarantee the stability of the product.

The stability test consists of incubating the product in an incubator for 7 days at 55° C. and 12 days at 37° C. The product is considered stable if the difference in pH thereof between the beginning of the incubation and the end is less than 0.4.

Particular attention must be paid to Staphylococcus aureus, which may produce toxins down to a water activity of 0.86. Its absence must be noted both upon goods inwards inspection of the raw materials and upon inspection of the finished products, although the various challenge tests have proved that survival, growth and production of toxins were impossible even with moderate heat treatment. Nonetheless, any raw material or any finished product liable to contain this type of microbe must be destroyed or eliminated.

It should be noted that the heat treatment, when moderate, is only one of the factors applied in hurdle technology, which allows microbial and organoleptic stability to be ensured and food safety to be guaranteed. This favourable action is obtained thanks to the combination of a number of other factors (hurdles). None of the factors is sufficient on its own to prevent microorganisms from developing. It is the combination thereof which ensures stability: experts explain this as a synergistic effect between the different factors.

The factors involved are:
water activity fixed between 0.70 and 0.92 and preferably between 0.85 and 0.90,
use of “clean” ingredients, that is to say containing a minimum of microbes and enzymes,
moderate lowering of the pH in the cakes and cake-based preparation where possible.
oxygen reduction to a very low level, of less than 4% or, even better, less than 1% in the mixture and in the finished product after packaging under inert gas,
use of gas having a bacteriostatic effect: N₂O or CO₂,
use of alcohol in certain recipes,
addition of salt in certain recipes, and
moderate pasteurising heat treatment at between 70° C. and 110° C., but sufficient to inactivate the enzymes and destroy residual or recontaminating heat-sensitive microbes.

Heat treatment may have another favourable action, in that it may deactivate certain enzymes; however, it is preferable to select raw materials which do not contain any, since certain of them are rendered inactive only by high temperature heat treatment.

In addition to the destruction of certain microbes and certain enzymes, the heat treatment ensures optimum baking of the cakes and culinary preparations.

It should be noted that the lower the density, the faster the heat would penetrate the product, which, at the same pasteurising value, makes it possible to achieve the baking sought in a shorter time. This is advantageous if it is necessary to preserve colour or to limit deterioration of the vitamins present or added.

It is also possible to vary the temperature and time, if it is necessary to promote the production of aromatic compounds in traditionally highly baked, very dark cakes.

Nutritional Advantages

Due to the higher water activity than in ordinary cakes with a long shelf life at ambient temperature, the calorific value is lower, being generally 5 to 15% less.

The possibility of applying only moderate heat treatment makes it possible to preserve the naturally present or added vitamins.

The use of hydrogenated fatty substances, whose trans fatty acid content is very controversial, is not necessary; excellent results are obtained with unsaturated oils such as rape-seed oil and even olive or walnut oil, which have the additional advantage of imparting their characteristic flavour, which makes it possible to dispense with the use of flavourings. Oxidation is not a risk, since foaming and packaging are performed under inert gas after deaeration of the base.

Presented below are four examples of cakes or cake-related preparations which may be manufactured using the method of the invention:

Chocolate cakes

| | |
|---|---|
| Deenzymed, heat-treated flour | 5 to 25% |
| Pasteurised egg | 10 to 30% |
| Emulsifier | 1 to 3% |
| Chocolate | 5 to 10% |
| Sugar | 15 to 30% |
| Anhydrous butter | 15 to 30% |

Fruit cake

| | |
|---|---|
| Deenzymed, heat-treated flour | 10 to 30% |
| Pasteurised, concentrated egg | 10 to 30% |
| Fruit concentrate | 5 to 20% |
| Filling: dehydrated, freeze-dried or glacé fruit | 5 to 10% |
| Sugar | 15 to 30% |
| Oil | 15 to 30% |

The two recipes given above are additive-free, but in certain cases the use of additives may be desirable to facilitate formulation and manufacture.

Olive cake

| | |
|---|---|
| Deenzymed, heat-treated flour or modified starches | 10 to 30% |
| Pasteurised, concentrated egg | 10 to 30% |
| Evaporated milk | 10 to 20% |
| Emulsifier | 1 to 3% |
| Salt | 1 to 2% |
| Glycerine | 1 to 5% |
| Cold-pressed olive oil | 15 to 30% |
| Pieces of dehydrated olives | 5 to 10% |

Muesli breakfast bar

| | |
|---|---|
| Precooked oat flakes | 5 to 10% |
| Mixture of heat-treated, deenzymed flours | 10 to 15% |
| Sugar or honey | 10 to 15% |
| Salt | 0.1 to 0.2% |
| Evaporated milk | 10 to 20% |
| Concentrated fruit juice | 3 to 8% |
| Filling: dehydrated, freeze-dried or glacé fruit | 5 to 15% |

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the principles of the present invention. Accordingly, the scope of the present invention should be determined by the following claims and their legal equivalents.

1. A method of manufacturing a ready-to-eat cake or culinary preparation with an extended shelf life at ambient temperature, comprising the steps of:
selecting a plurality of ingredients having a low water content;
preparing a base with said ingredients;
foaming said base under inert gas pressure to achieve a desired volume and densite;
packing said base in a container; and
applying a vacuum before closing said container.

2. The method according to claim 1, further comprising the step of deaerating said base prior to said foaming step.

3. The method according to claim 2, in which said water content of said ingredients results in a base water activity value of between approximately 0.70 and 0.92.

4. The method according to claim 3, in which said water activity value is 0.85, 0.90, or therebetween.

5. The method according to claim 2, further comprising the step of subjecting said base to a stabilisation treatment that destroys microbes.

6. The method according to claim 5, in which said water content of said ingredients results in a base water activity value of between approximately 0.70 and 0.92.

7. The method according to claim 6, in which said water activity value is 0.85, 0.90, or therebetween.

8. The method according to claim 5, further comprising the step of subjecting said base to a pasteurisation treatment.

9. The method according to claim 8, in which said water content of said ingredients results in a base water activity value of between approximately 0.70 and 0.92.

10. The method according to claim 9, in which said water activity value is 0.85, 0.90, or therebetween.

11. The method according to claim 1, further comprising the step of subjecting said base to a stabilisation treatment that destroys microbes.

12. The method according to claim 11, in which said water content of said ingredients results in a base water activity value of between approximately 0.70 and 0.92.

13. The method according to claim 12, in which said water activity value is 0.85, 0.90, or therebetween.

14. The method according to claim 11, further comprising the step of subjecting said base to a pasteurisation treatment.

15. The method according to claim 14, in which said water content of said ingredients results in a base water activity value of between approximately 0.70 and 0.92.

16. The method according to claim 15, in which said water activity value is 0.85, 0.90, or therebetween.

17. The method according to claim 1, in which said water content of said ingredients results in a base water activity value of between approximately 0.70 and 0.92.

18. The method according to claim 17, in which said water activity value is 0.85, 0.90, or therebetween.

19. A ready-to-eat cake or culinary preparation made according to the method steps of claim 1.
